(19) United States
(12) Patent Application Publication
(10) Pub. No.: US 2006/0013192 A1
(43) Pub. Date: Jan. 19, 2006

(54) Obtaining and notifying middle box information

(75) Inventors: Franck Le, Irving, TX (US); Zhigang Liu, Coppell, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/966,096

(22) Filed: Oct. 18, 2004

Related U.S. Application Data
(60) Provisional application No. 60/588,348, filed on Jul. 16, 2004.

(51) Int. Cl. H04L 12/28

(52) U.S. Cl. 370/351

(57) ABSTRACT

Signaling between a terminal equipment and a session server is provided which carries information on an expected media stream to or from the terminal equipment via a middle box for optimizing the performance of data communications between the terminal equipment and a correspondent node. On the basis of this information the session server is enabled to create appropriate entries in a security entity provided for the terminal equipment so that the media stream can successfully traverse the middle box and the security entity.

### REFERENCE TO RELATED APPLICATIONS

This application claims priority of U.S. Provisional Patent Application Ser. No. 60/588,348 filed on Jul. 16, 2004, the contents of which are hereby incorporated by reference.

### FIELD OF THE INVENTION

The present invention relates to data communication networks, and in particular to the use of middle boxes in a network for optimizing the performance of data communications.

### BACKGROUND OF THE INVENTION

Different types of middle boxes are being developed and will be deployed in communication networks. For example, Performance Enhancement Proxies (PEPs) have been developed to optimize the performance of data communications over different network accesses such as wireless links which are error prone and are bandwidth limited. PEPs may be used to perform real-time conversions of content from e-mail, Web page, and enterprise application sources into forms that can be directly absorbed by a wide variety of mobile devices. Moreover, PEPs can significantly increase an end user's experience by using different methods including content modification, protocol optimizations, etc. The PEP features e.g. include compression, ‘banners stripping’, TCP modifications, etc.

There are different types of PEPs: some, server only, are transparent to the clients. Others, also called client-server, require the client to be aware of the PEP server.

When deploying these network entities in cellular networks such as 3GPP (Third Generation Partnership Project) networks, e.g. to improve the performance of the data communications over the radio link which is not only very bandwidth limited but also error prone, the interaction with firewalls/NATs (Network Address Translators) may however present issues that can either prevent the optimizations from happening or even prevent the packets from being exchanged between communicating nodes. The packets may even be dropped at the firewall/NAT.

Furthermore, when considering deployment of PEPs over different types of networks, a roaming UE (User Equipment) needs to know if a visited network is offering any PEP features, what features the visited network supports, and finally some negotiation may be needed (depending on the type of PEP feature).

In case PEPs are deployed by corporate networks, clients can be configured with the PEP information of the corporate network, but when considering deployment of PEP in other types of networks such as 3GPP networks, several issues arise:

Selection between security and optimization: The UE may not know whether the visited network is offering PEP support or not. The UE may therefore decide to apply security (Internet Protocol security, Transport Layer Security) but the PEP cannot in such case be used to optimize the data communications. As an example, a PEP feature integrated in a GGSN (GPRS (General Packet Radio Service) Gateway Support Node) may implement ‘banners stripping’ to reduce the data to be sent over the air interface and thus optimize the performance of the data communication. However, if the UE applies IPsec or TL security, such feature will not be applicable since both encryption and integrity protection will prevent modification to the payload. Thus, even for server-only PEP features (UE transparent mode), the UE needs to know whether the visited network is offering PEP services or not in order to make an informed decision to choose between security and optimization for data that can be transmitted either with or without security.

Inability to take advantages of the PEP features: The UE not knowing that the network is supporting PEP features may not be able to take advantage of them. As an example, new protocols have been defined to optimize the delivery of packets over wireless networks.

Current transport protocols provide poor performance over wireless networks, and thus the Wireless profiled TCP (Transport Control Protocol) and Wireless Datagram Protocol to be used instead of TCP and UDP (User Datagram Protocol) over wireless links have been defined.

Wireless Profiled TCP is a modified version of standard TCP, which includes a number of modifications to TCP. Four major modifications (window size control algorithm, TCP slow start function, data resend function in the event of a transmission error; data size) have been considered and other extensions have been defined. Wireless Datagram Protocol (WDP)/Wireless Session Protocol (WSP)/Wireless Transaction Protocol (WTP) is a set of protocols to optimize connection-less packets transmission over wireless networks.

These protocols have been defined for WAP (Wireless Application Protocol), but could be used for any application (IP Multimedia, etc.) to optimize the delivery of packets over the air interface.

Current UE terminals are configured with WAP gateway configuration information and when they need to use WAP application, they connect to the WAP Gateway (activating the WAP Access Point Name).

As for other PEP features that need the client to be aware of, the client is typically preconfigured with the PEP information. This is e.g. the case for corporate deployment of PEPs.

However, in the scenario of the GGSN having additional processing capabilities and features, the UE may be roaming to visited networks that offer PEP features and to some other networks that do not. Currently, the UE is not aware of offered PEP features in a visited network and, thus, will not utilize the PEP functionality at the visited network. That is obviously a loss of performance in cases where there is no PEP functionality in the home network of the UE. Even if there is PEP functionality in the home network of the UE, it may still be impossible or at least less efficient for the UE to utilize PEP back at the home network instead of PEP at the visited network. For example, optimization techniques targeting a radio link should in general, and sometimes must, be applied in a location closer to the radio link.

### SUMMARY OF THE INVENTION

It is therefore an object of the present invention to enable an efficient usage of middle boxes for enhancing communications performance in networks.

This object is achieved by a method and apparatus for providing signaling between a terminal equipment and a session server. The signaling carries information on an expected media stream to or from the terminal equipment via a middle box for optimizing the performance of data communications between the terminal equipment and a correspondent node. On the basis of this information the session server is enabled to create appropriate entries in a security entity provided for the terminal equipment so that the media stream can successfully traverse the middle box and the security entity. Alternatively, the security entity may create the entries itself using the signaling information.

The invention may also be implemented as computer program product.

According to the invention, middle boxes such as PEPs can be appropriately configured and a media stream can successfully traverse all of them.

Moreover, the invention provides a framework in which a UE can—access independently—discover the existence of a PEP and its capabilities. That allows an easy deployment of PEP features in a network and a better utilization of those features to optimize data communications.

Furthermore, a flexible and dynamic configuration of the PEPs is enabled.

For example, if the UE terminal supports WDP/WSP/WTP, and a GGSN also does so, these protocols could be used instead of TCP/UDP. The GGSN is enabled to advertise its support for W-TCP and WDP. If the UE terminal also supports these protocols, it can inform the network accordingly, and then the communication can be carried over these transport protocols for a better performance of the data communication.

As yet another example, some performance optimization features (e.g. data compression) require software implementation in both the network (i.e. PEP) and the UE. In this case, the UE and PEP are enabled to discover that the other side supports the same feature so that it can be utilized.

Besides PEP discovery, more control of PEP configuration by UEs is provided. Configurations in the following three aspects are supported and allowed:
Per UE configuration, not just per UE type.
Dynamic configuration, not just one time.
Finer granularity and parameter configuration/adjustment.

This invention therefore defines mechanisms to perform PEP discovery, PEP features advertisement and PEP negotiation. The proposed mechanisms are flexible enough to support different possible PEP deployment scenarios. The invention is applicable to PEPs which are transparent to the UEs and to PEPs which the UE has to be aware of.

### BRIEF DESCRIPTION OF THE DRAWINGS

FIG. 1 shows a schematic block diagram illustrating a terminal and a serving entity according to an embodiment of the invention.

FIGS. 2 to 5 show schematic block diagrams illustrating a network structure in which signaling according to implementation examples of the invention is deployed.

FIG. 6 shows a payload header for advertising PEP capabilities according to an embodiment of the invention.

FIG. 7 shows a schematic block diagram illustrating a network structure in which signaling according to the prior art is deployed.

### DESCRIPTION OF THE PREFERRED EMBODIMENTS

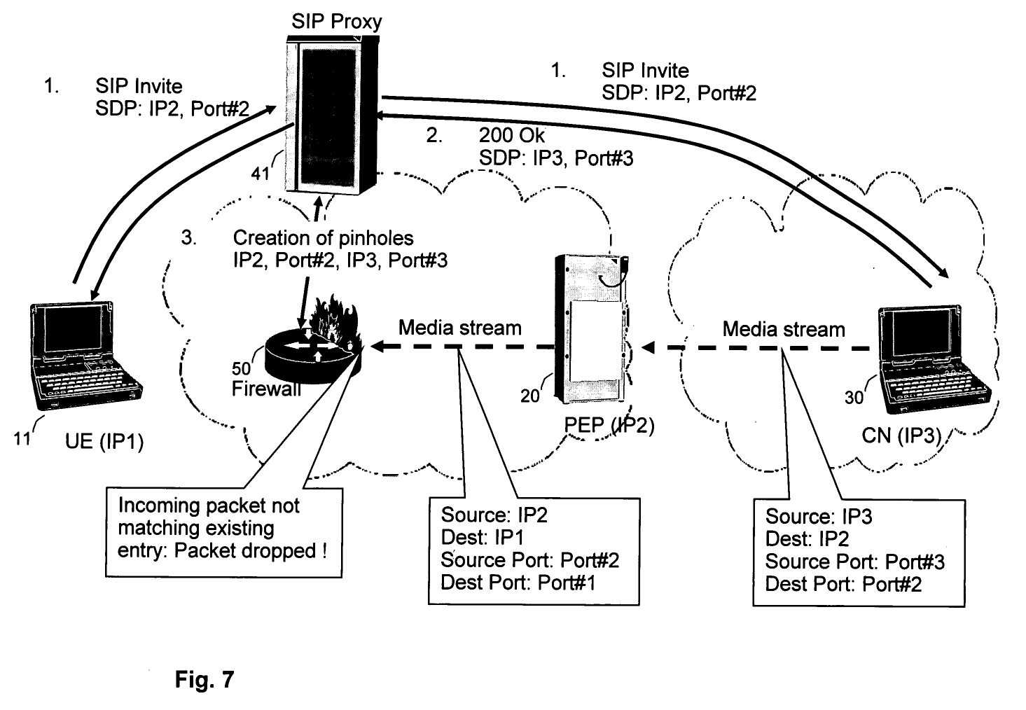

At first, a problem of interaction with firewalls/NATs arising when middle boxes are placed in a network system using signaling according to the prior art will be described with reference to FIG. 7.

In order to illustrate and explain the problem, a UE accessing IP Multimedia Subsystem (IMS) is assumed. The problem described in the following is however not restricted to this implementation and use case but is also applicable in many other environments/scenarios where middle boxes such as PEPs and security entities such as firewall/NATs have to co-exist.

FIG. 7 shows a UE (IP1) 11 establishing a communication via SIP (Session Initiation Protocol) with a CN (Correspondent Node) (IP3) 30. The UE is protected by a firewall 50, and a client-server PEP (IP2) 20 is used in order to optimize the performance of the data communication.

The UE 11 initiates a call by sending a SIP Invite request to the CN 30 via the IMS, i.e. via a SIP-proxy such as a P-CSCF (Proxy-Call Session Control Function) or S-CSCF (Serving-CSCF)) 41. In order to make sure that packets sent from the CN 30 are routed through the PEP 20, the UE 11 specifies the IP address of the PEP 20 (i.e. IP2) in the SDP field as shown in communications 1 in FIG. 7.

Assuming the CN 30 accepts the call, the CN 30 replies with a 200 OK message in communication 2, specifying the IP address and the port number (i.e. IP3 and Port#3) where it expects a media stream.

Upon receiving the 200 SIP OK message from the CN 30, the SIP-proxy 41 knows that the CN 30 accepted the call and therefore opens the appropriate pinholes in the firewall 50 (communications 3 in FIG. 7). The pinholes are created based on the SDP fields of the SIP signaling. The entries are therefore for a media stream between IP2, Port#2 and IP3, Port#3.

For downlink traffic (from CN to UE), the packets are sent from the CN 30 to the PEP 20. After performing the required operations, the PEP 20 modifies at least the destination IP address of the packet so that it can be routed to the UE 11. The PEP 20 may also modify the port numbers, e.g. for protocol optimization, more particularly if Wireless TCP is used between the UE 11 and the PEP 20 to improve the performance of the data communications over the cellular link. The downlink packets arriving at the firewall 50 do not therefore match any existing entry of the firewall, and are dropped.

For uplink traffic (from UE to CN), the packets are first sent to the PEP 20 so that optimization such as protocol optimizations (e.g. W-TCP) to improve the performance of the data communication over the cellular link can be performed. The packets are thus sent from the IP address IP1 of the UE 11 to the IP address IP2 of the PEP 20, whereas the pinhole created in the firewall 50 for this media stream indicates ‘from IP2 to IP3’. Thus, the uplink packets do not match the existing firewall entries and are dropped. Layer 4 information (i.e. port information) may also differ due to the PEP 20.

Therefore, neither uplink nor downlink packets may be able to be delivered to their destination. The problem results from the following reasons:
The pinholes in the firewall 50 are created based on the information from the SDP fields of the SIP signaling exchanged between the two communicating nodes at the call set-up.
For downlink packets, the SIP signaling must indicate the IP address of the PEP 20 so that the CN 30 sends the media stream packets to that IP address and the PEP 20 is thus put on the traffic path and can perform the required optimization operations.
The PEP 20 may however modify L3 and L4 information (i.e. the IP address and port information) for routing and optimization purposes and as a result the packets arriving at the firewall 50 do not match the pinholes.
For uplink packets, the pinhole in the firewall 50 is created based on the SDP field sent by the CN 30: it typically indicates where the CN expects to receive the media stream. However, in order to take advantage of the PEP features, the UE 11 must send the packets to the PEP 20 first. As a result, uplink packets arriving at the firewall 50 do not match the pinholes and are therefore dropped.

When analyzing the problem, there may by two straightforward solutions:

First, as a problem results from the fact that the Firewall 50 is disposed between the UE 11 and the PEP 20, a first solution could be to avoid such situation. However, this is not always possible. As an example, in the 3GPP IMS, the GGSN implements firewall functionality and it would be difficult to place the PEP between the UE and the GGSN (due to, for instance, GT (GPRS Tunneling protocol) and mobility issues). On the contrary, most probably, the GGSN will be located between the UE and the PEP, and therefore the issues identified above apply.

Second, as a problem arises from the fact that the PEP 20 may modify the L3 and L4 information, another possible solution would be to have the PEP on the path and not modifying the source/destination IP addresses. This may result in a loss of the flexibility of placing the PEP anywhere in the network, but would avoid having the PEP changing the IP addresses information. This would more particularly solve the IP addresses mismatch of the media stream packets with the firewall states. However, current PEP products may not allow that feature, and PEP may also have to modify the L4 information (protocol numbers) e.g. when W-TCP or other more efficient transport protocols are adopted between the UE and the PEP.

For overcoming the above problem arising from middle box-firewall interaction, extensions to a signaling protocol are defined to carry information on an expected media stream so that a network can appropriately set up a path for user data.

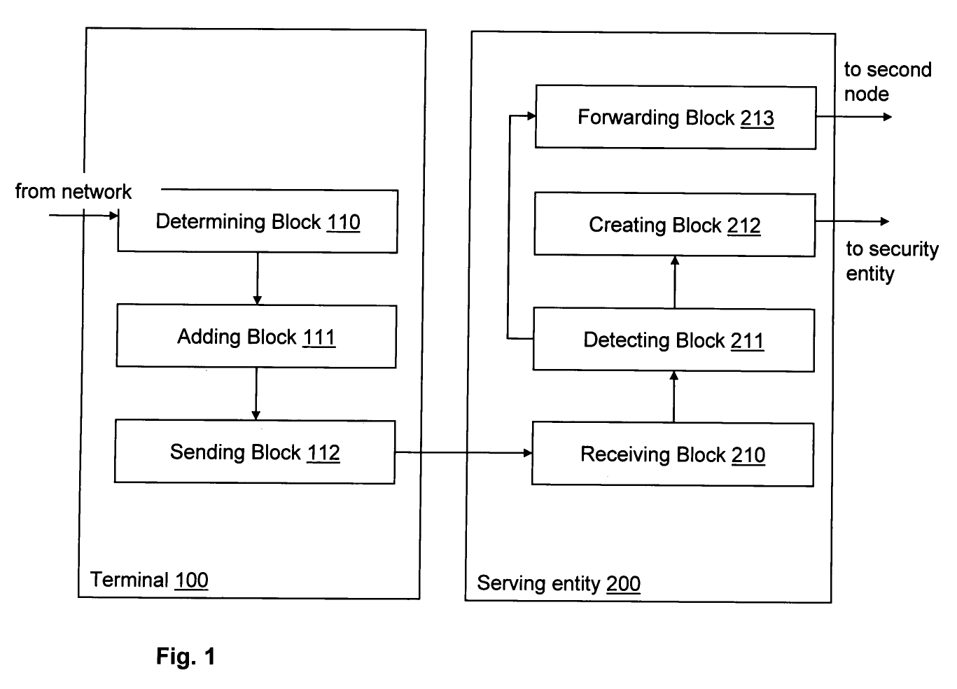

FIG. 1 shows a terminal 100 such as a user equipment or mobile node, and a serving entity 200 such as a SIP-proxy, P/S-CSCF of an IMS in a network system for communicating data. The terminal 100 comprises a determining block 110, an adding block 111 and a sending block 112. In case the determining block 110 determines that in a session to be set up a media stream is to be transmitted between the terminal and a second node (not shown) such as a correspondent node via a third node (not shown) such as a middle box or PEP for enhancing communication between the terminal and the second node, the adding block 111 adds, to a message for initiating a session with the second node, data indicating an address of the third node and third node information indicating that the media stream is transmitted to or from the terminal via the third node. The adding block 111 may add an address of the first node as third node information. In addition, the adding block 111 may further add an address of the third node or an address of the second node as third node information. The third node information added by the adding block 111 may be dependent on the direction of the media stream, i.e. from the second node towards the first node or from the first node towards the second node. The sending block 112 then sends the message towards the second node. The sending block 112 may send the message via the serving entity 200 serving the message for initiating the session.

The serving entity 200 comprises a receiving block 210, a detecting block 211, and a creating block 212. In case the receiving block 210 receives from the terminal 100 the message for initiating the session with the second node, and the detecting block 211 detects the data indicating the address of the third node and the third node information, the creating block 212 creates entries in a security entity (not shown) such as a firewall provided for the first node on the basis of the third node information.

The serving entity 200 may further comprise a forwarding block 213 which forwards the message for initiating the session to the second node. The forwarding block 213 may remove the third node information from the message before forwarding the message to the second node.

Alternatively, the security entity may receive the message for initiating the session with the second node and may detect the data indicating the address of the third node and the third node information and create the entries itself. For this purpose, the security entity may comprise receiving, detecting and creating blocks similar to the blocks 210 to 212 of the serving entity 200.

The entries in the security entity may be created using the third node information alone or in combination with information provided in a response message to the message for initiating the session, which response message is sent from the second node.

It is to be noted that the message for initiating a session as described above comprises either a first message (e.g. SIP INVITE) or a reply message (e.g. 200 OK) to the first message.

According to implementation examples to be described in the following, extensions to a known Session Description Protocol are defined so that middle boxes can be appropriately configured and the media stream can successfully traverse all of them.

It is to be noted that the invention can be implemented in several ways and is not restricted to the following implementation example.

As described with respect to FIG. 7, currently same SDP fields are used to both (i) inform a correspondent node (CN) of an IP address (at L3) and transport (i.e. L4) protocol where a receiver expects a media stream, and (ii) create a pinhole in a firewall.

As described above, the problem results from the fact that the CN must be informed of PEP information (since packets must first be sent to the PEP) whereas the pinholes in the firewall must be created for packets exchanged between a UE and the PEP.

In order to solve this problem, an extra field, “f”, is introduced in the Session Description Protocol (SDP). As a result, the UE specifies connection data (i.e. an IP address) in a “c” field, transport information in an “m” field, and middle boxes information in the “f” field or “f” fields. The “f” fields indicate the rules to be installed in the firewall for the media stream. Pinholes in the firewall will then be created based on the “f” fields. The “f” fields may have the following format:
‘f’=<direction><source IP address><destination IP address><transport protocol><source port number><destination port number><action>
   <direction> is optional. It indicates the direction of the media flow, i.e. uplink or downlink. <action> indicates whether packets matching the rule should “pass” or be “dropped”.

This allows handling different scenarios:
case 1: PEP changes source IP address, SIP initiated call;
case 2: PEP changes source IP address, SIP terminated call;
case 3: PEP does not change source IP address, SIP initiated call;
case 4: PEP does not change source IP address, SIP terminated call.

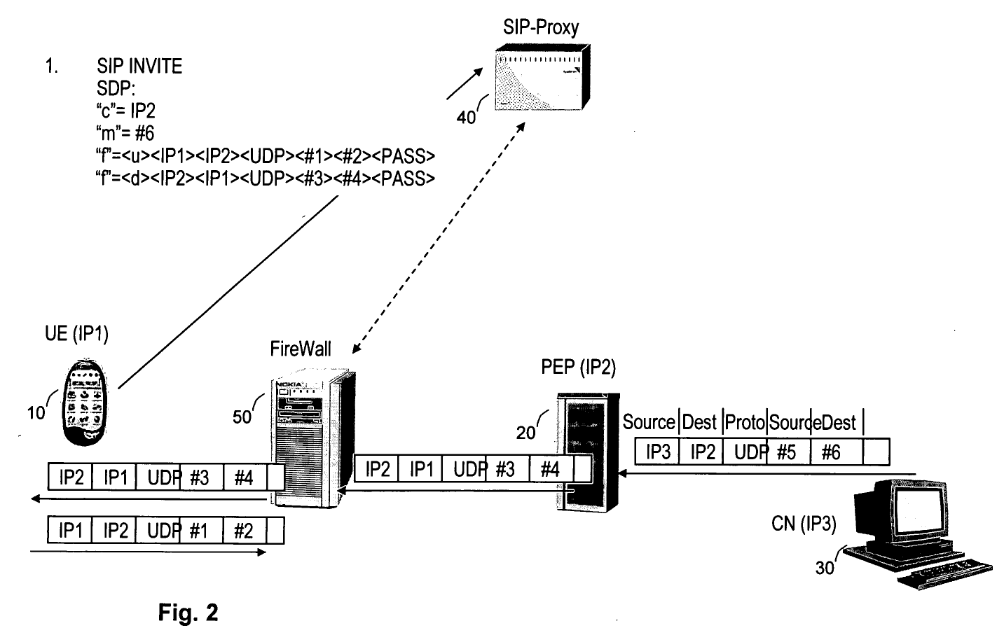

Referring to FIGS. 2 to 5 it will be described how the “f” fields are used to create the appropriate pinholes in the firewall according to the above-described different scenarios.

A P/S-CSCF in an IMS or SIP aware firewall then uses the information, not in the “c” field as in the prior art, but the one indicated in the “f” field(s) to open the pinholes in the firewall.

The P/S-CSCF may remove the “f” field before forwarding a SIP message to the CN so that the CN does not have any information about the network topology.

The format of the proposed “f” field depends on standardization, but it should contain the L3 address(es) and optionally the L4 information.

With the introduction of the “f” field in SDP, only the UE or MN and the SIP servers (and SIP aware firewalls) are affected. Other network entities (e.g. SIP unaware firewall, GGSN, etc.) do not need to be changed.

FIG. 2 illustrates an implementation example in case the PEP changes the source IP address and in case of a SIP initiated call. In FIG. 2 a UE (IP1) 10 establishes a communication via SIP with the CN (IP3) 30. The UE is protected by the (SIP unaware) firewall 50, and the client-server PEP (IP2) 20 is used in order to optimize the performance of the data communication.

The UE 10 initiates a call by sending a SIP Invite request to the CN 30 via IMS (i.e. via a SIP-proxy, P-CSCF or S-CSCF) 40. In order to make sure that packets sent from the CN 30 are routed through the PEP 20, the UE 10 specifies the IP address of the PEP 20 (i.e. IP2) in the SDP “c” field, the transport information (i.e. Port#6) in the SDP “m” field, and the PEP 20 information in the SDP “f” fields as shown in communication 1 from the UE 10 to the SIP-proxy 40. The SIP-proxy 40 may remove the SDP “f” fields before forwarding the SIP Invite request to the CN 30 in a communication from the SIP-proxy 40 to the CN 30 (not shown).

As shown in communication 1 in FIG. 2, the “c” field indicates IP2 so that the CN (IP3) 30 sends packets to the PEP first as shown in FIG. 2. The PEP 20 changes the source and destination IP address and the source and destination ports to IP2, IP1, #3, #4 as shown in FIG. 2. It is to be noted that ports #3 and #4 may or may not be the same as ports #5 and #6, respectively.

The SDP “f” fields in the SIP Invite message indicate the rules to be installed in the firewall 50 for the media stream. The SIP-proxy creates the pinholes in the firewall 50 based on the “f” fields.

The “f” field for the downlink direction (d) includes the IP address of the PEP 20 as source IP address, the IP address of the UE 10 as destination IP address, a port #3 as source port number and a port #4 as destination port number.

The “f” field for the uplink direction (u) includes the IP address of the UE 10 as source IP address, the IP address of the PEP 20 as destination IP address, a port #1 as source port number and a port #2 as destination port number. In practice, the ports #1 and #4, and the ports #2 and #3 most of the time—but not always—are the same.

The UE 10 may alternatively specify:
“f”=<u><IP1><IP2><UDP><*><#2><PASS>
“f”=<d><IP2><IP1><UDP><*><#4><PASS>

That means the source port number will not be checked for filtering packets. This allows the sender to choose the source port from which it wants to send the media stream.

According to the scenario shown in FIG. 2, the entries in the firewall 50 are for a media stream in the downlink direction between IP2, Port#3 and IP1, Port#4, and for a media stream in the uplink direction between IP1, Port#1 and IP2, Port#2.

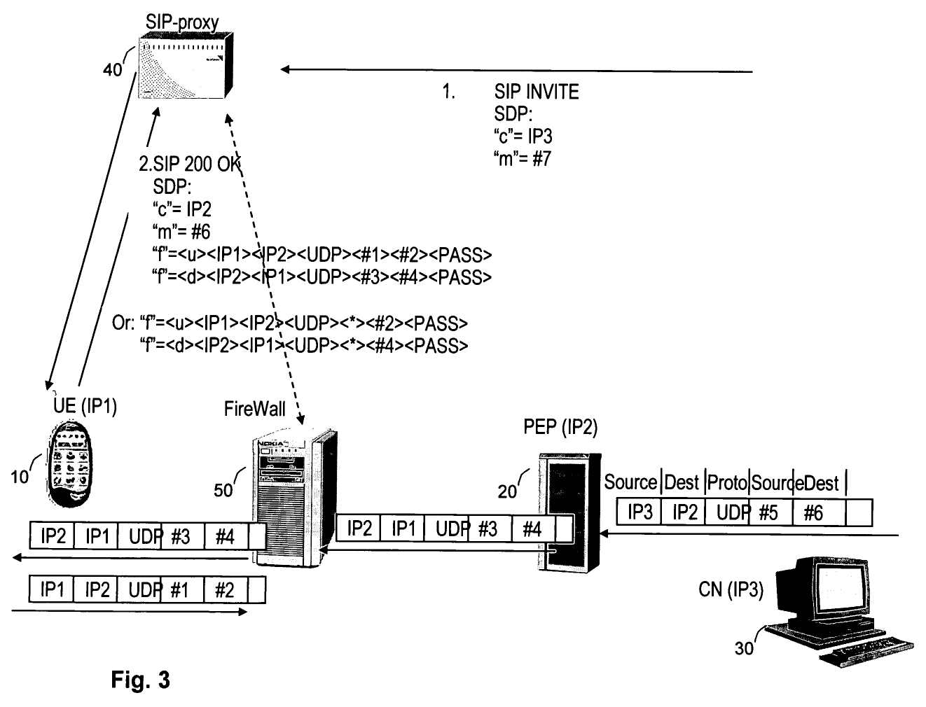

FIG. 3 illustrates an implementation example in case the PEP changes the source IP address and in case of a SIP terminated call. In FIG. 3 the CN (IP3) 30 establishes a communication via SIP with the UE (IP1) 10. The UE is protected by the (SIP unaware) firewall 50, and the client-server PEP (IP2) 20 is used in order to optimize the performance of the data communication.

The CN 30 initiates a call by sending a SIP Invite request to the UE 10 via the SIP-proxy 40. In order to make sure that packets sent from the UE 10 are routed to the CN 30, the CN 30 specifies its IP address in the SDP “c” field and its transport information (i.e. Port#7) in the SDP “m” field, as shown in communication 1 in FIG. 3.

Upon receiving the SIP Invite request, the UE 10 responds with a message as shown in communication 2 in FIG. 3. In order to make sure that packets sent from the CN 30 are routed through the PEP 20, the SDP “c”, “m” and “f” fields are specified by the UE 10 in the same way as shown in communication 1 in FIG. 2.

The UE 10 may alternatively specify:
“f”=<u><IP1><IP2><UDP><*><#2><PASS>
“f”=<d><IP2><IP1><UDP><*><#4><PASS>

That means the source port number will not be checked for filtering packets. This allows the sender to choose the source port from which it wants to send the media stream.

According to the scenario shown in FIG. 3, the entries in the firewall 50 are for a media stream in the downlink direction between IP2, Port#3 and IP1, Port#4, and for a media stream in the uplink direction between IP1, Port#1 and IP2, Port#2.

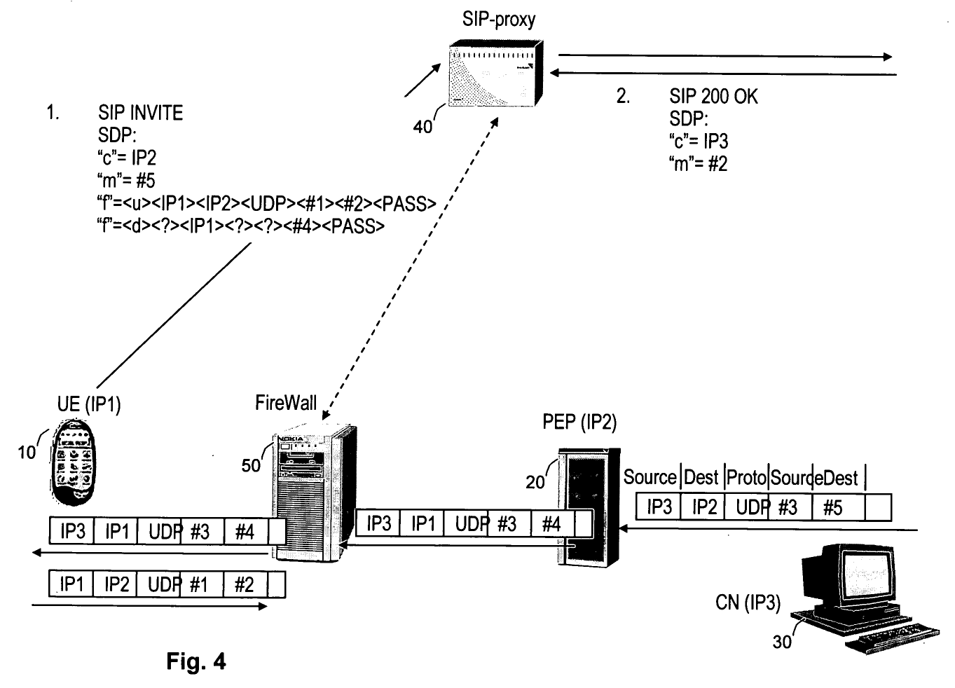

FIG. 4 illustrates an implementation example in case the PEP does not change the source IP address and in case of a SIP initiated call. In FIG. 4 the UE (IP1) 10 establishes a communication via SIP with the CN (IP3) 30. The UE is protected by the (SIP unaware) firewall 50, and the client-server PEP (IP2) 20 is used in order to optimize the performance of the data communication.

The UE 10 initiates a call by sending a SIP Invite request to the CN 30 via the SIP-proxy 40. In order to make sure that packets sent from the CN 30 are routed through the PEP 20, the UE 10 specifies the IP address of the PEP 20 (i.e. IP2) in the SDP “c” field, the transport information (i.e. Port#5) in the SDP “m” field, and the PEP 20 information in the SDP “f” fields as shown in communication 1 in FIG. 4. However, for downlink traffic, when sending the SIP Invite the UE 10 does not know the characteristics of the CN 30, i.e. the IP address, transport protocol and source port number of the CN 30. Thus, the “f” field for the downlink direction includes “?” for the unknown fields. The SIP-proxy 40 complements them with information provided in the SDP field of the response message ‘SIP 200 OK’ from the CN 30 (communication 2 in FIG. 4) for creating the pinholes in the firewall 50.

In other words, assuming the CN 30 accepts the call, the CN 30 replies with a 200 OK message in communication 2, specifying the IP address and the port number (i.e. IP3 and Port#2) where it expects a media stream for uplink. The 200 OK message also indicates that the CN 30 accepts the transport protocol that has been requested by the UE 10 for downlink media stream in the INVITE message in communication 1.

Upon receiving the 200 SIP OK message from the CN 30, the SIP-proxy 40 knows that the CN 30 accepted the call and gets the IP address of the CN 30, and therefore opens the appropriate pinholes in the firewall 50. Note that the SIP proxy 40 may not know the value of source port (#3 shown in FIG. 4) for downlink media stream. In that case, it may specify “*” for the field, meaning the source port number will not be checked to filter downlink packets.

For uplink, the destination IP address is IP2 since the UE 10 wants the packets to go through the PEP 20. The final destination (i.e. IP3) is carried in a Routing Header according to IPv6 or a Loose Secure and Record Route Option according to IPv4, or agreed between the UE 10 and the PEP 20 via other protocols/methods.

The SIP-proxy 40 may remove the SDP “f” fields before forwarding the SIP Invite request to the CN 30 from the SIP-proxy 40 to the CN 30.

As shown in communication 1 in FIG. 4, the “c” field indicates IP2 so that the CN (IP3) 30 sends packets to the PEP first as shown in FIG. 4. The PEP 20 does not change the source IP address and the source port as shown in FIG. 4.

The “f” field for the downlink direction (d) includes “?” for the source IP address, the IP address of the UE 10 as destination IP address, “?” for the source port number and a port #4 as destination port number.

The “f” field for the uplink direction (u) includes the IP address of the UE 10 as source IP address, the IP address of the PEP 20 as destination IP address, a port #1 as source port number and a port #2 as destination port number. For downlink, the ports #4 and #5 may be equal in which case the PEP does not change the destination port number.

The UE 10 may alternatively specify:
“f”=<u><IP1><IP2><UDP><*><#2><PASS>
“f”=<d><?><IP1><?><*><#4><PASS>

That means the source port number will not be checked for filtering packets. This allows the sender to choose the source port from which it wants to send the media stream.

The pinholes are created based on the SDP “f” field of the SIP signaling between the UE 10 and the SIP-proxy 40 and the SDP fields of the SIP signaling between the CN 30 and the SIP-proxy 40. The entries are therefore for a media stream in the downlink direction between IP3, Port#3 and IP1, Port#4, and for a media stream in the uplink direction between IP1, Port#1 and IP2, Port#2.

The “?” indication instructs the serving entity such as a P-CSCF or a SIP aware firewall to complement the pinholes with information received in a SIP 200 OK as reply to a SIP INVITE message including the SDP having the “f” field.

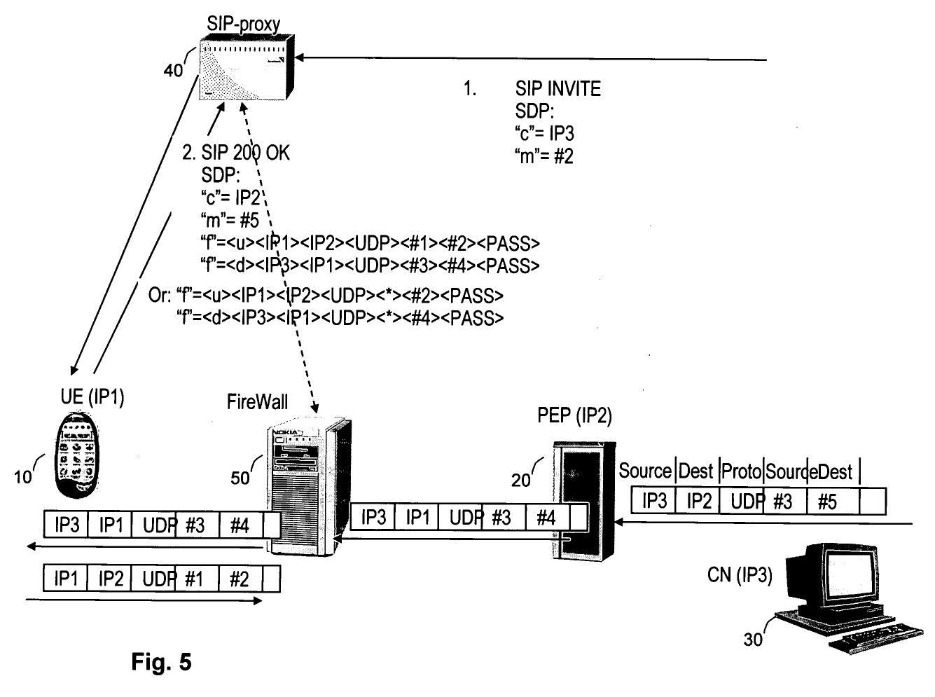

FIG. 5 illustrates an implementation example in case the PEP does not change the source IP address and in case of a SIP terminated call. In FIG. 5 the CN (IP3) 30 establishes a communication via SIP with the UE (IP1) 10. The UE is protected by the (SIP unaware) firewall 50, and the client-server PEP (IP2) 20 is used in order to optimize the performance of the data communication.

The CN 30 initiates a call by sending a SIP Invite request to the UE 10 via the SIP-proxy 40. In order to make sure that packets sent from the UE 10 are routed to the CN 30, the CN 30 specifies its IP address in the SDP “c” field and the port number (i.e. Port#2) where it expects a media stream in the SDP “m” field, as shown in communication 1 in FIG. 5.

Upon receiving the SIP Invite request, the UE 10 responds with a message “SIP 200 OK” as shown in communication 2 in FIG. 5. In order to make sure that packets sent from the CN 30 are routed through the PEP 20, the UE 10 specifies the IP address of the PEP 20 (i.e. IP2) in the SDP “c” field, the transport information (i.e. Port#5 as the receiving port number) in the SDP “m” field, and the PEP 20 information in the SDP “f” fields as shown in communication 2 in FIG. 5. The UE 10 complements the “f” field for the downlink direction with the IP address, transport protocol and port number of the CN 30 which information is provided in the SDP field of the SIP Invite message from the CN 30.

The UE 10 may alternatively specify:
“f”=<u><IP1><IP2><UDP><*><#2><PASS>
“f”=<d><?><IP1><?><*><#4><PASS>

That means the source port number will not be checked for filtering packets. This allows the sender to choose the source port from which it wants to send the media stream.

The pinholes are created based on the SDP “f” field of the SIP signaling between the UE 10 and the SIP-proxy. The entries are therefore for a media stream in the downlink direction between IP3, Port#3 and IP1, Port#4, and for a media stream in the uplink direction between IP1, Port#1 and IP2, Port#2.

As shown in FIGS. 2 to 5, for downlink traffic (from CN to UE), the packets are sent from the CN 30 to the PEP 20. After performing the required operations, the PEP 20 modifies at least the destination IP address of the packet into IP1 so that it can be routed to the UE 10. The PEP 20 may also modify the port numbers into Port#4, e.g. for protocol optimization, more particularly if Wireless TCP is used between the UE 10 and the PEP 20 to improve the performance of the data communications over the cellular link. Thus, the downlink packets arriving at the firewall 50 match the entry (IP1, Port#4, IP3, Port#3) or (IP1, Port#4, IP2, Port#3) of the firewall, and can be forwarded to the UE 10.

For uplink traffic (from UE to CN), the packets are first sent to the PEP 20 so that optimization such as protocol optimizations (e.g. W-TCP) to improve the performance of the data communication over the cellular link can be performed. The packets are thus sent from the IP address IP1 of the UE 10 to the IP address IP2 of the PEP 20. Since the pinhole created in the firewall 50 for this media stream indicates ‘from IP1 to IP2’, the uplink packets match an existing firewall entry and are forwarded to the PEP 20.

For indicating the information on the expected media stream, the terminal (UE or MN (Mobile Node)) is required to be aware of all the middle boxes, e.g. IP addresses of PEPs and port numbers that will be used in the data packets. For example, the UE can be pre-configured with the IP addresses of the PEPs, and regarding the port numbers, the UE may be configured to know the functionality of a PEP and more particularly if the PEP may modify the transport protocol (e.g. W-TCP instead of TCP, etc.). In this case, the UE is able to know the port numbers that will be indicated in the data packets and can indicate them in the SDP so that firewalls can be appropriately configured.

Alternatively, the UE, may learn the information about the middle boxes or PEPs by at least one of the procedures of PEP discovery, advertisement of PEP capabilities and negotiation to be described in the following.

PEP discovery: A mechanism for a UE is defined to learn whether a visited network is offering PEP services or not, and if yes, a method for the UE is defined to learn the location of the PEP servers.

Several mechanisms are actually possible and allow both the UE to initiate the procedure or the network to initiate it. Different implementations alternatives are described below.

Advertisement of PEP capabilities: A method is defined for a network to advertise PEP capabilities supported. Different methods are described below.

Negotiation: A method is specified for a UE and a network to negotiate and agree on the features to be applied to the data communications. The method also allows the UE to renegotiate PEP features it desires at any time after an initial negotiation. The UE may e.g. tell the network whether banners stripping should be applied to its data communications. Also if compression is adopted, the UE and the network should agree on the algorithm to be used. The negotiation procedure is further described below.

Depending on the PEP deployment scenarios, one, two or the three of these procedures may be adopted. The proposed mechanisms allow different features to be supported which is described below.

As a first example, advertisement of PEP capabilities only may be enough: The visited network can advertise the offered PEP features to its visiting users. These can include banners strippers and/or other features. By default, these services may be applied to the data communications. Thus the visiting UE can learn the supported PEP features and decide whether to take advantage of them or not. The UE may decide that security of its data is more important and prefer to use IPsec or other security protocols to encrypt/integrity protect its data.

Alternatively, the UE may prefer to take advantage of the PEP features and not protect its data so that the PEP can modify and optimize the performance. This is the case where the negotiation of PEP features is not supported or needed.

As a second example, PEP discovery and negotiation may be enough: when roaming to a visited network, the UE attempts to discover if any PEPs are present or not. The PEP discovery procedure will allow the UE to learn whether such network entity is offered in the visited network, and if yes, the UE may perform a negotiation procedure with which the UE learns the supported features. The UE and the visited network may e.g. negotiate on the algorithms for compression.

Many other scenarios are possible, and therefore the PEP discovery, the advertisement of PEP capabilities and the negotiation procedures are defined to be as flexible as possible. An implementation may choose the appropriate combination of the three procedures as needed. Each of the procedures can be implemented in different ways. Some of them are GPRS specific, while others are generic. As further described below, both the UE and the network may initiate the procedures.

PEP Discovery:

According to an implementation example, an IP address of a PEP may be provided to a UE by using DHCP (Dynamic Host Configuration Protocol). By providing a domain name of a PEP, as well as an address of a DNS (Domain Name Server) that can resolve the domain name of the PEP, the UE can learn whether the visited network is supporting PEP services and if yes, it can also learn the IP address(es) of the PEP server(s) by performing a DNS query.

Alternatively, the IP address(es) of the PEP can be transmitted by a GGSN to a UE in a Protocol Configuration Option of a PDP (Packet Data Protocol) Context Activation Accept signaling. Specifically, the IP address(es) of the PEP can be carried either in a known additional parameters list or a known configuration protocol options list. The former is preferable since it makes the PEP discovery in line with how the P-CSCF and DNS server addresses are handled in 3GPP.

The Protocol Configuration Options have been defined to exchange data (e.g. configuration parameters, error codes or messages/events) between a UE or MS (Mobile Station) and a network. If the configuration protocol options list contains a protocol identifier that is not supported by a receiving entity a corresponding unit is to be discarded. And if the additional parameters list contains a container identifier that is not supported by the receiving entity the corresponding unit is to be discarded. Therefore, this proposal does not cause any issue with non-supporting legacy terminals/networks since unrecognized options are just discarded but the remaining of the signaling data are still processed. However, care should be taken to handle the possibility that the container or protocol ID may collide with another independent proprietary enhancement. One solution is to assign a value for implementation of this PEP discovery feature. The second option is to use an unused value—particularly a large value to reduce collision probability—for the container or protocol ID. In addition, the signaling should include a “magic pattern” to further reduce the chance of the collision. The third option is to use a scheme similar to the known “ALFIP Capability Determination” to detect if a visited SGSN/GGSN supports proprietary enhancements.

The above described PEP discovery using PDP context signaling is only applicable in GRPS access, but has the main advantages of being efficient. Using this mechanism, the UE can also initiate the procedure by sending a Protocol configuration Option in a PDP context Activation Request message to the network, in order to discover whether the visited network is offering PEP services or not.

As a further alternative, the known Service Location Protocol is another method that could be used for the UE to find out whether the network is offering PEP services or not. However this solution requires the deployment of SLP agents, and requires the terminals to support the SLP protocol. Finally, it is not efficient either since the UE has to discover the SLP agents first whereas in wireless networks, the air interface is a limited and expensive resource.

Advertisement of PEP Capabilities:

According to an implementation example, new Protocol Configuration Options are defined to describe PEP services supported and offered by a network. The Protocol Configuration Options are then included in PDP Context messages sent from the network to a UE (e.g. PDP Context Activation Accept message).

Alternatively, a new protocol is defined allowing the network to advertise the PEP features supported and offered to nodes. This protocol can be access independent and therefore be used over WLAN, GPRS and other accesses.

There are several ways how this protocol can be implemented:

According to a first way of implementing the protocol, PEP capabilities may be periodically advertised as the current router advertisement messages. The PEP capabilities may either be advertised in a new L3 or above layer protocol or as extensions to the router advertisements messages. With this mechanism, the UE learns the existence and the capabilities of the PEP at the same time. No prior PEP discovery is required. However, if the PEP capabilities description is long, this may result in an inefficient utilization of the air interface.

Another possibility is to define a new protocol which is e.g. similar to ISAKMP. ISAKMP is a negotiation protocol for security purposes. The PEP protocol may be inspired from ISAKMP for the procedures, the reliability and the packets formats but is designed to advertise and negotiate the PEP features that are supported and the ones to be used. The PEP protocol may be run over TCP or UDP. TCP already supports handling of out of sequence packets and packets loss whereas UDP does not.

After discovering the address of the PEP, the UE sends a request with its supported capabilities. The network compares these supported capabilities with the PEP features it supports and replies with the ones that could be applied and optionally some other alternatives. The UE confirms the PEP features that it will like to be used for the data communications.

Alternatively, the UE may send a request asking the network to initiate the supported PEP features advertisement. The UE then decides which one of the supported PEP features it would like to use. The exchange may be composed of several round trips, i.e. may involve negotiation.

The above procedure may also define messages to stop the utilization of the PEP features, and the modification of them. A packet format strongly depends on standardization, but a Type-Length-Value type of packet format may be used to advertise the PEP features. The type would indicate what PEP feature is supported. A MIB (Management Information Base) is required, and a value field may carry required information. Actually, the packet format also depends on the PEP features: some require parameters, some do not, some require negotiation, etc. As an example, if compression is decided to be adopted, the algorithm needs to be agreed on, whereas for banner stripping, no negotiation of parameters is required.

As described above, the protocol can re-use the principles of ISAKMP. ISAKMP has defined the set up phase, the advertisement, the negotiation and all other required procedures.

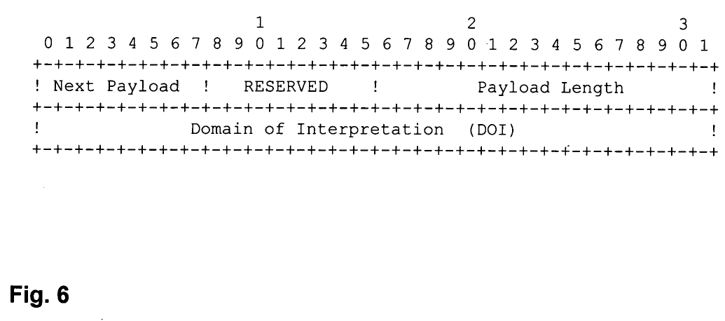

The PEP payload header may be built as shown in FIG. 6, where “Next Payload” (1 octet) is an identifier for a payload type of next payload in a message. If a current payload is the last in the message, then this field will be 0. “RESERVED” (1 octet) is unused and set to 0. “Payload Length” (2 octets) is the length in octets of the entire payload, including proposal payloads, and all information associated with the proposed PEP feature. “Domain of Interpretation” (4 octets) identifies the DOI under which this negotiation is taking place. The DOI is a 32-bit unsigned integer. Similarly to IANA, the Domain of Interpretation defines the values to be used for negotiating the different possible algorithms, and other parameters. It allows the nodes involved in the negotiation procedure to understand and to be able to exchange the supported capabilities. For example, an IPsec DOI has been defined.

The PEP payload header is followed by the PEP feature description/proposals. As described above, the format strongly depends on the type of the feature. A Type may indicate the supported PEP feature and the meaning of the following information.

Negotiation:

According to a first implementation example, new Protocol Configuration Options are defined to negotiate and agree on the PEP features to be applied on the data communications. Such options are used in PDP context signaling and may e.g. be used to agree on the algorithm to be used for compression.

Alternatively a new protocol, like the one described above for the advertisement of PEP capabilities, is defined allowing the network and the UE to negotiate and agree on the PEP features to be applied on the data communication. The benefit of this approach is that the new protocol can be access independent and therefore be used over WLAN, GPRS and other accesses.

The framework and procedures described above can be applied to the scenarios where PEP functionality is distributed in the network, rather than located at a single location. Depending on the distributed architecture, there are two ways of applying this invention. The first one assumes that there is a central server (may be either one of the PEP resources or a proxy representing PEP resources) which controls the distributed PEP functionality. In that case, a client can simply discover and negotiate with the central server as described previously. The second one is the case where there is no such central server. In that architecture, a client can discover and negotiate with each PEP resource as desired in the network using the above described implementation examples. As yet another dimension, the type of networks also affects the PEP architecture, and thus ways to apply this invention. For example, in GPRS, the SGSN/GGSN may act as the central server. This involves an advantage since the GPRS specific solution, which is ‘piggybacked’ on PDP context activation, requires little change to existing protocols.

It is to be understood that the above description is illustrative of the invention and is not to be construed as limiting the invention. Various modifications and applications may occur to those skilled in the art without departing from the true spirit and scope of the invention as defined by the appended claims.

1. A method of communicating data in a communication network, the method comprising the steps of:
determining that a media stream is to be transmitted between a first node and a second node via a third node for enhancing communication between the first and second nodes;
adding, to a message for initiating a session, data indicating an address of the third node and third node information indicating that the media stream is transmitted to or from the first node via the third node; and
sending the message towards the second node.

2. The method according to claim 1, wherein the adding step comprises adding an address of the first node as the third node information.

3. The method according to claim 1, wherein the adding step comprises adding an address of the first node and an address of the second node as the third node information.

4. The method according to claim 1, wherein the adding step comprises adding an address of the first node and the address of the third node as the third node information.

5. The method according to claim 1, wherein the adding step comprises adding the third node information for the media stream from the first node and adding the third node information for the media stream to the first node.

6. The method according to claim 1, wherein the sending step comprises sending the message towards the second node via a serving entity serving the message for initiating the session.

7. The method according to claim 1, comprising the step of discovering at least one of a third node capability of the communication network or the address of the third node by using Dynamic Host Configuration Protocol.

8. The method according to claim 1, comprising the step of discovering at least one of a third node capability of the communication network or the address of the third node by using Packet Data Protocol context signaling.

9. The method according to claim 1, comprising the step of discovering at least one of a third node capability of the communication network or the address of the third node by using Service Location Protocol.

10. The method according to claim 1, comprising a step of recognizing at least one of a third node capability of the communication network or the address of the third node from an advertisement of third node capabilities.

11. The method according to claim 10, comprising using Packet Data Protocol signaling for the advertisement.

12. The method according to claim 10, comprising using a negotiation protocol for the advertisement.

13. The method according to claim 10, comprising the step of requesting the advertisement from the communication network.

14. The method according to claim 1, comprising the step of negotiating third node capabilities with the communication network.

15. A computer program embodied in a computer readable medium, comprising software code portions for performing, when the program is run on a computer, the steps of:
determining that a media stream is to be transmitted between a first node and a second node via a third node for enhancing communication between the first and second nodes in a communication network;
adding, to a message for initiating a session, data indicating an address of the third node and third node information indicating that the media stream is transmitted to or from the first node via the third node; and
sending the message towards the second node.

16. A terminal for communicating data in a communication network, the terminal comprising:
determining means for determining that a media stream is to be transmitted between the terminal and a second node via a third node for enhancing communication between the terminal and the second node;
adding means for adding, to a message for initiating a session, data indicating an address of the third node and third node information indicating that the media stream is transmitted to or from the terminal via the third node; and
sending means for sending the message towards the second node.

17. A method of serving a session in a communication network, the method comprising the steps of:
receiving from a first node a message for initiating a session with a second node;
detecting, from the received message, data indicating an address of a third node via which a media stream is to be transmitted between the first node and the second node for enhancing communication between the first and second nodes and third node information indicating that the media stream is transmitted to or from the first node via the third node; and
creating entries in a security entity provided for the first node on the basis of the third node information.

18. The method according to claim 17, further comprising the step of forwarding the message for initiating the session to the second node, wherein the forwarding step comprises removing the third node information from the message before forwarding the message to the second node.

19. The method according to claim 17, wherein
the receiving step comprises receiving a second node message for initiating the session from the second node, the second node message comprising data indicating an address of the second node, and
the creating step comprises creating the entries in the security entity on the basis of the third node information and the address of the second node.

20. A computer program embodied in a computer readable medium, comprising software code portions for performing, when the program is run on the computer, the steps of:
receiving from a first node a message for initiating a session with a second node;
detecting, from the received message, data indicating an address of a third node via which a media stream is to be transmitted between the first node and the second node for enhancing communication between the first and second nodes, and third node information indicating that the media stream is transmitted to or from the first node via the third node; and
creating entries in a security entity provided for the first node on the basis of the third node information.

21. A serving entity for serving a session in a communication network, the serving entity comprising:
receiving means for receiving from a first node a message for initiating a session with a second node;
detecting means for detecting, from the received message, data indicating an address of a third node via which a media stream is to be transmitted between the first node and the second node for enhancing communication between the first and second nodes, and third node information indicating that the media stream is transmitted to or from the first node via the third node; and
creating means for creating entries in a security entity provided for the first node on the basis of the third node information.

22. A security entity having security entries for protecting data communications in a communication network, the security entity comprising:
receiving means for receiving from a first node a message comprising a message for initiating a session with a second node;
detecting means for detecting, from the received message, data indicating an address of a third node via which a media stream is to be transmitted between the first node and the second node for enhancing communication between the first and second nodes, and third node information indicating that the media stream is transmitted to or from the first node via the third node; and
creating means for creating security entries on the basis of the third node information.

23. A network system for communicating data, the network system comprising a terminal and a serving entity,
the terminal comprising:
determining means for determining that a media stream is to be transmitted between the terminal and a second node via a third node for enhancing communication between the terminal and the second node;
adding means for adding, to a message for initiating a session, data indicating an address of the third node and third node information indicating that the media stream is transmitted to or from the terminal via the third node; and
sending means for sending the message towards the second node, the serving entity comprising:
receiving means for receiving from the terminal the message for initiating the session with the second node;
detecting means for detecting the data indicating the address of the third node and the third node information from the received message; and
creating means for creating entries in a security entity provided for the first node on the basis of the third node information.
